(19) United States
(12) Patent Application Publication
(10) Pub. No.: US 2011/0187352 A1
(43) Pub. Date: Aug. 4, 2011

(54) METHOD AND MACHINE FOR MULTIDIMENSIONAL TESTING OF AN ELECTRONIC DEVICE ON THE BASIS OF A MONODIRECTIONAL PROBE

(75) Inventor: Philippe Perdu, Toulouse (FR)

(73) Assignee: Centre National D'Etudes Spatiales (C.N.E.S.), Paris Cedex 01 (FR)

(21) Appl. No.: 13/001,482

(22) PCT Filed: Jun. 24, 2009
(86) PCT No.: PCT/FR2009/051204

§ 371 Date: Apr. 7, 2011

(30) Foreign Application Priority Data
Jun. 25, 2008 (FR) 08.03567

(51) Int. Cl. G01B 7/14

(52) U.S. Cl. 324/207.11

(57) ABSTRACT

In a method and a machine for testing an electronic device, in which the magnetic field emitted is measured by a monodirectional measurement probe, a first value of the component Bz of the magnetic field along axis ZZ′ is measured by the probe and recorded. The probe and the electronic device are displaced with respect to one another by relative pivoting about an axis XX′ orthogonal to axis ZZ′, according to an angular amplitude of less than 90° while maintaining distance d0 and, for each position (x, y) of axis ZZ′, a second value of component Bz of the magnetic field along axis ZZ′ is measured by the probe and recorded, then the value of component By of the magnetic field along axis YY′ orthogonal to axes ZZ′ and XX′ is determined and recorded on the basis of the first value and the second value which have been obtained.

The invention relates to a method and a machine for testing an electronic device.

Throughout the text, the expression “electronic assembly” refers to any integral set of electronic components in a plurality of pieces, which are connected and joined to one another according to a predetermined electrical circuit while most often having external connection terminals; this may, for example, involve printed circuit boards (PCB) assemblies (called SiP or “System in Package”) of integrated circuits (with active components (microprocessors, memories, etc.) and/or passive components (resistors, capacitors inductors, etc.) and/or microsystems (for example MEMS)) in a single package, the various pieces being mounted beside one another and/or stacked and/or embedded in multilayer or other structures; the electrical connections in these electronic assemblies, in particular between the various pieces, may be produced by means of conductive tracks, by welding, by connection wires (“wire bonding”), by adhesive bonding (“flip-chip”) etc.

It is necessary that the electronic devices such as integrated circuits and electronic assemblies can be tested, for various purposes, in particular for the detection and localization of faults, or for assistance in design or determination of their characteristics.

One of the known methods for performing these tests consists in supplying the electronic device with electrical energy and with predetermined input signals (test vectors), then in carrying out measurements on the electronic device in operation. Particularly, due to the great miniaturization and the very large integration scales of modern electronic devices, the measurements are most often carried out under microscopy. Furthermore, one of the non-destructive measurement techniques which is envisaged consists in detecting at least one magnetic field induced in immediate proximity to the electronic device by the circulation of currents inside this electronic device. In particular, it is known that it is possible to carry out imaging of the currents flowing in the electronic device by means of a magnetic probe (such as a magnetoresistive sensor or a SQUID sensor: “superconducting quantum interference device”) arranged in proximity to the device. Such a probe makes it possible to evaluate a component Bz of the magnetic field along a predetermined axis ZZ′ which is fixed with respect to the probe (generally corresponding to a longitudinal axis of the probe) and thus makes it possible to carry out two-dimensional imaging of the component Bz in a plane orthogonal to the axis ZZ′ of the probe. On the basis of this two-dimensional image of the magnetic field, assumed to be parallel to the observed object which is considered to be of zero thickness, the two-dimensional distribution of the currents flowing on this object can be evaluated by calculation.

However, modern electronic devices such as electronic assemblies are increasingly often being designed in three dimensions. Such a probe, the effectiveness of which presupposes that the thickness of the measured object is negligible compared with the distance between the probe and the object, is not suitable for evaluating and carrying out imaging of the currents which are far away from the probe, within the thickness of the electronic device.

The solution which has been envisaged in order to resolve this problem (INFANTE F: “Failure Analysis for System in Package devices using Magnetic Microscopy” THESIS XP009114669 (date of publication not specified); US2003/0001596), consists in carrying out a plurality of measurements on different faces of the electronic device, a probe being oriented along different mutually orthogonal axes, so as to obtain various two-dimensional images which, by combination with one another and reconstruction, could make it possible to obtain an evaluation of the currents. However, such a method involving combination of two-dimensional images does not make it possible to accommodate all the situations which may be encountered in three dimensions inside the circuit, for example if there are a plurality of conductive lines which are neither coplanar nor orthogonal to one another, or conductive lines not extending parallel to the planes detected by the probe or in loops, or when the electronic device is not in the shape of a cube. Furthermore, a prerequisite for the conduct of measurements along three orthogonal directions in front of three orthogonal faces of the electronic device is a particularly complex measurement machine comprising three orthogonal probes, or successive manipulations of the electronic device in order to present different faces of this electronic device in front of the probe, which is both time-consuming and not very reliable.

In this context, it is an object of the invention to provide a test method and machine making it possible, on the basis of a measurement probe of the monodirectional type, to obtain a measurement non-limited to the axial component Bz of the magnetic field emitted by the electronic device.

More particularly, it is an object of the invention to provide a test method and a machine making it possible to carry out measurements allowing evaluation of the circulation of currents not only in the plane orthogonal to the axis ZZ′ of the probe but also in at least one plane parallel to this axis ZZ′.

In particular, it is an object of the invention to provide such a test method and such a machine which make it possible to obtain, with great reliability and high precision, a representation of all three components of the magnetic field induced by the circulation in three dimensions of the currents in the electronic device, solely on the basis of measurements carried out by a monodirectional probe arranged in front of only one face of the electronic device.

It is also more particularly an object of the invention to provide such a method and such a machine which can be used for the detection and localization of faults in electronic devices of the three-dimensional type, for example electronic assemblies.

In order to achieve this, the invention provides a method for testing an electronic device, in which the magnetic field emitted by at least one circulation of electric current in the electronic device is measured by a monodirectional measurement probe adapted to be able to deliver a signal representative of the value of a component Bz of said magnetic field along a predetermined axis ZZ′ which is fixed with respect to said probe, wherein:
the probe being brought to a distance d0 in front of one face of the electronic device with the axis ZZ′ secant with the electronic device, and the electronic device being supplied with electrical energy and with predetermined input signals applied to input terminals of the electronic device, for each position (x, y) of the axis ZZ′ with respect to said face, a first value Bz1 of the component of the magnetic field Bz along the axis ZZ′ is measured by the probe and recorded,
then the probe and the electronic device are displaced with respect to one another by relative pivoting about an axis XX′ orthogonal to the axis ZZ′ according to an angular amplitude of less than 90°, the probe being kept at the same distance d0 in front of the same face of the electronic device, and, the electronic device being supplied with electrical energy and with predetermined input signals, for each position (x, y) of the axis ZZ′ with respect to said face, a second value Bz2 of the component of the magnetic field Bz along the axis ZZ′ is measured by the probe and recorded,
then the value of a component By of the magnetic field along an axis YY′ orthogonal to the axes ZZ′ and XX′ is determined and recorded on the basis of the first value Bz1 and the second value Bz2 which have been obtained.

Specifically, the invention is based on the observation according to which, on the basis of two measurements of the same component Bz of the magnetic field carried out with angular different positions (less than 90°—in particular less than 45°—between them) of the electronic device with respect to the probe about an axis XX′ orthogonal to the axis ZZ′ of the probe, it is possible to calculate the value of a second component By of the magnetic field.

Furthermore, by pivoting the electronic device and the probe with respect to one another about a third axis YY′ orthogonal to the first two (and only about this third axis YY′, a direction which passes through the face of the electronic device, and which is orthogonal to the second axis XX′ being orthogonal to the axis ZZ′, the electronic device not being pivoted about said second axis XX′ with respect to its position for measuring the first value Bz 1 of the component Bz of the magnetic field), it is also possible to calculate the value of a third component Bx of the magnetic field. Thus, advantageously, a method according to the invention is also one wherein:
the probe and the electronic device are displaced with respect to one another by relative pivoting about the axis YY′ according to an angular amplitude of less than 90°, the probe being kept at the same distance d0 in front of the same face of the electronic device, and, the electronic device being supplied with electrical energy and with predetermined input signals, for each position (x, y) of the axis ZZ′ with respect to said face, a third value Bz3 of the component Bz of the magnetic field along the axis ZZ′ is measured by the probe and recorded,
then the value of a component Bx of the magnetic field along an axis XX′ is determined and recorded on the basis of the first value Bz1 and the third value Bz3 which have been obtained.

A test method according to the invention may, in particular, be used for the detection and localization of faults in the electrical circuit of the electronic device.

Thus, a method according to the invention is advantageously also one wherein:
an image, called a measured image, of at least a part of the electronic device is formed on the basis of one of the three components Bx, By, Bz of the magnetic field emitted by this electronic device, as determined on the basis of the measurements provided by said probe for different positions (x, y) of the axis ZZ′ of the probe with respect to said face,
a plurality of simulated images of said part of the electronic device are formed by simulation, each simulated image corresponding to an image capable of being obtained in the same way as the measured image, on the basis of values calculated by simulation, for each position (x, y) of the axis ZZ′ with respect to said face, of the corresponding component Bx, By, Bz of the magnetic field as would be emitted by this electronic device in the presence of at least one fault of the circulation of current in said part of the electronic device,
the simulated images are compared with the measured image.

This comparison may be carried out by a human user (visual comparisons) or on the other hand automatically, for example by using software for processing and comparison of images (for example the image processing software WIT® from the company DALSA Digital Imaging (Burnaby, Canada). It is to be noted in this regard that producing simultaneous images and comparing these simultaneous images with the measured image makes it possible to obviate any calculation of the strength of the current on the basis of the values of the components of the magnetic field, a calculation which does not always have a simple analytical solution. Furthermore, this image comparison makes it possible to overcome measurement errors due to the very principle of this measurement, in particular errors due to the distance which necessarily exists between the probe and the electronic device, since these errors are contained both on the measured image and on the simulated images.

By suitably selecting the various simulated images, as a function of the nature of the electrical circuit, it is possible to localize a fault in the electrical circuit rapidly.

In particular, advantageously and according to the invention, the measured image of said part of the electronic device, which is used for the comparison, corresponds to subtraction of an image (or the corresponding matrix) obtained on the basis of the corresponding measured component Bx, By, Bz of the magnetic field emitted by the entirety of a reference electronic device corresponding to the electronic device to be tested but free of faults, this component being measured for each position (x, y) of the axis ZZ′ with respect to said face, and of an image (or the corresponding matrix) obtained on the basis of the corresponding measured component Bx, By, Bz of the magnetic field emitted by the entirety of the electronic device to be tested, this component also being measured for each position (x, y) of the axis ZZ′ with respect to said face, and each simulated image is formed by subtraction of an image (or the corresponding matrix) obtained on the basis of values calculated by simulation, for each position (x, y) of the axis ZZ′ with respect to said face, of the corresponding component Bx, By, Bz of the magnetic field as would be emitted by the entirety of the reference electronic device, and of an image (or the corresponding matrix) obtained on the basis of values calculated by simulation, for each position (x, y) of the axis ZZ′ with respect to said face, of the corresponding component Bx, By, Bz of the magnetic field as would be emitted by the entirety of the electronic device in the presence of at least one fault. In this way all the parts of the electronic device, and therefore of the corresponding images, which are free of faults, are subtracted and are not used in the comparison, which is therefore particularly simple, precise and rapid.

As a variant, there is nothing to prevent the use of other methods for selecting the circuit portions to be simulated. In the case of complex circuits, for example, it is possible to make hypotheses by iterations on volume portions of the electronic device which are liable to contain at least one fault, and at each iteration, to carry out simulations and a comparison only on one volume portion. Conversely, in the case of simple circuits, the measured image and each simulated image may correspond to the entirety of the electronic device.

Advantageously and according to the invention, a measurement probe comprising a sensor selected from a SQUID sensor and a magnetoresistive sensor is used.

Furthermore, a method according to the invention is advantageously also one wherein, the electronic device being an electronic assembly in three dimensions, in order to measure said first value Bz1 the probe is oriented with the axis ZZ′ orthogonal to one of the external faces of this electronic assembly—in particular a main face (upper or lower face of largest size) of this electronic assembly.

In a method according to the invention, in order to pivot the probe and the electronic device with respect to one another, it is possible either to displace the probe with respect to a frame on which the electronic device is kept fixed, or to displace the electronic device with respect to a frame, with respect to which at least the orientation of the axis ZZ′ of the probe is kept fixed, or to displace both the probe and the electronic device simultaneously with respect to a common frame.

Advantageously and according to the invention, the probe and the electronic device are displaced with respect to one another by relative pivoting according to an angular amplitude of more than 10° and less than 45°—in particular lying between 10 and 30°

The invention extends to a test machine adapted to carry out a test method according to the invention.

The invention thus also provides a machine for testing an electronic device, comprising:
a monodirectional measurement probe adapted to be able to deliver a signal representative of the value of a component Bz, along a predetermined axis ZZ′ which is fixed with respect to said probe, of the magnetic field emitted in the vicinity of the probe by at least one circulation of electric current in the electronic device,
a support for receiving an electronic device, and means for supplying this electronic device with electrical energy and with predetermined input signals applied to input terminals of the electronic device,
a mechanism suitable for placing the probe and an electronic device received in the reception support with respect to one another, with the axis ZZ′ secant with the reception support,
means for recording values corresponding to the signals delivered by the probe,
   wherein:
said mechanism is configured to make it possible to modify, for each position (x, y) of the axis ZZ′ with respect to the electronic device, the orientation of the probe and the electronic device with respect to one another, by relative pivoting about an axis XX′ orthogonal to the axis ZZ′ according to an angular amplitude of less than 90°, the probe being kept at a distance d0 in front of the same face of the electronic device,
it comprises calculation means configured to determine and record, for each position (x, y) of the axis ZZ′ with respect to said face, the value of a component By of the magnetic field along an axis YY′ orthogonal to the axes ZZ′ and XX′, on the basis of a first value Bz1 of the component Bz of the magnetic field along the axis ZZ′ as measured by the probe in a first relative angular position of the probe and of the electronic device with respect to the axis XX′, and of a second value Bz2 of the component Bz of the magnetic field along the axis ZZ′ as measured by the probe in a second relative angular position of the probe and of the electronic device with respect to the axis XX′, and at the same distance d0, said first and second angular positions with respect to the axis XX′ being separated from one another by an angle of less than 90°—in particular less than 45°.

Advantageously and according to the invention, said mechanism is also configured to make it possible to modify the orientation of the probe and the electronic device with respect to one another, by relative pivoting about the axis YY′ according to an angular amplitude of less than 90°, the probe being kept at the same distance d0 in front of the same face of the electronic device, and said calculation means are configured to determine and record, for each position (x, y) of the axis ZZ′ with respect to said face, the value of a component Bx of the magnetic field along the axis XX′, on the basis of a first value Bz1 of the component Bz of the magnetic field along the axis ZZ′ as measured by the probe in a first relative angular position of the probe and of the electronic device with respect to the axis YY′, and of a third value Bz3 of the component Bz of the magnetic field along the axis ZZ′ as measured by the probe in a second relative angular position of the probe and of the electronic device with respect to the axis YY′, and at the same distance d0, said first and second angular positions with respect to the axis YY′ being separated from one another by an angle of less than 90°.

Furthermore, advantageously and according to the invention, said measurement probe comprises a sensor selected from a SQUID sensor and a magnetoresistive sensor.

Advantageously and according to the invention, a machine according to the invention furthermore comprises:
means for generating an image, called a measured image on the basis of one of the three components Bx, By, Bz of the magnetic field emitted by this electronic device, as determined on the basis of the measurements provided by said probe for different positions (x, y) of the axis ZZ′ of the probe with respect to said face,
means for calculating calculated values by simulation, for each position (x, y) of the axis ZZ′ with respect to said face, of the three components Bx, By, Bz of the magnetic field as would be emitted by said part of the electronic device in the presence of at least one fault of the circulation of current in said part of the electronic device,
means for generating a plurality of simulated images of said part of the electronic device by simulation, each simulated image corresponding to an image capable of being obtained in the same way as the measured image, on the basis of a set of said values calculated by simulation, for each position (x, y) of the axis ZZ′ with respect to said face, of the corresponding component Bx, By, Bz of the magnetic field.

Furthermore, advantageously and according to the invention:
the reception support is arranged to be able to receive an electronic device formed by an electronic assembly in three dimensions,
the mechanism is configured to make it possible to orientate the probe with the axis ZZ′ orthogonal to one of the external faces of an electronic assembly received in said support.

In a first variant, advantageously and according to the invention, the support for receiving the electronic device is fixed with respect to a frame, and said mechanism is configured to make it possible to pivot the probe with respect to this frame. In a second variant, advantageously and according to the invention, the probe is mounted with respect to a frame so as to have a fixed orientation of the axis ZZ′ with respect to the frame, the mechanism is configured to make it possible to pivot the support for receiving the electronic device with respect to the frame, and the electronic device received in the support is supplied by means of a twisted cable.

The invention also relates to a test method and machine which in combination have all or some of the characteristics mentioned above or below.

Other objects, characteristics and advantages of the invention will become apparent on reading the following description of several of its preferred embodiments, which are given only by way of non-limiting examples and refer to the appended figures, in which:

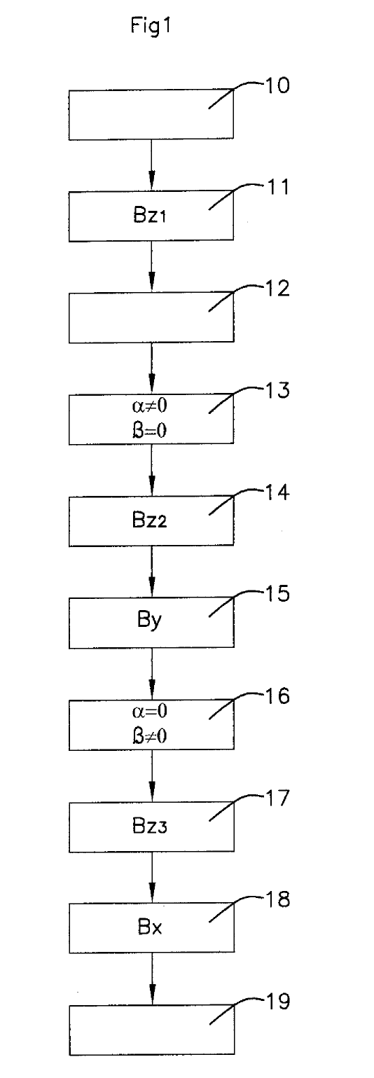

FIG. 1 is a general flow chart of a test method according to an embodiment of the invention,

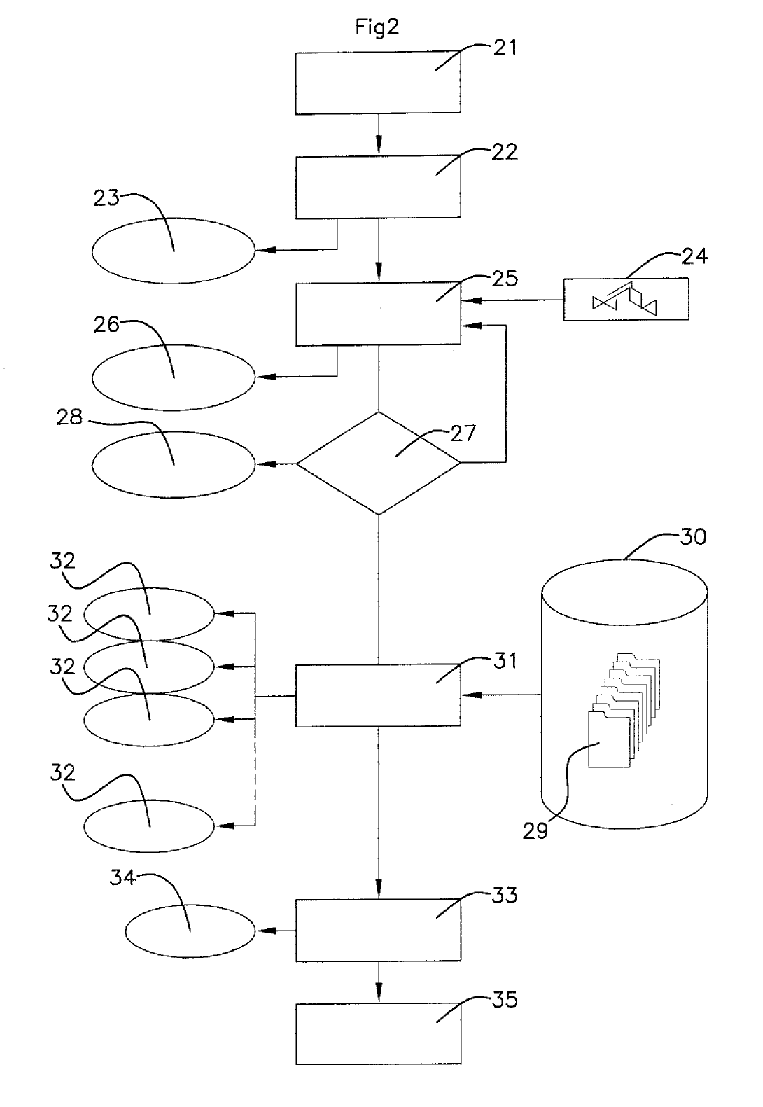

FIG. 2 is a flow chart illustrating a method according to the invention for the detection and localization of faults by image comparison,

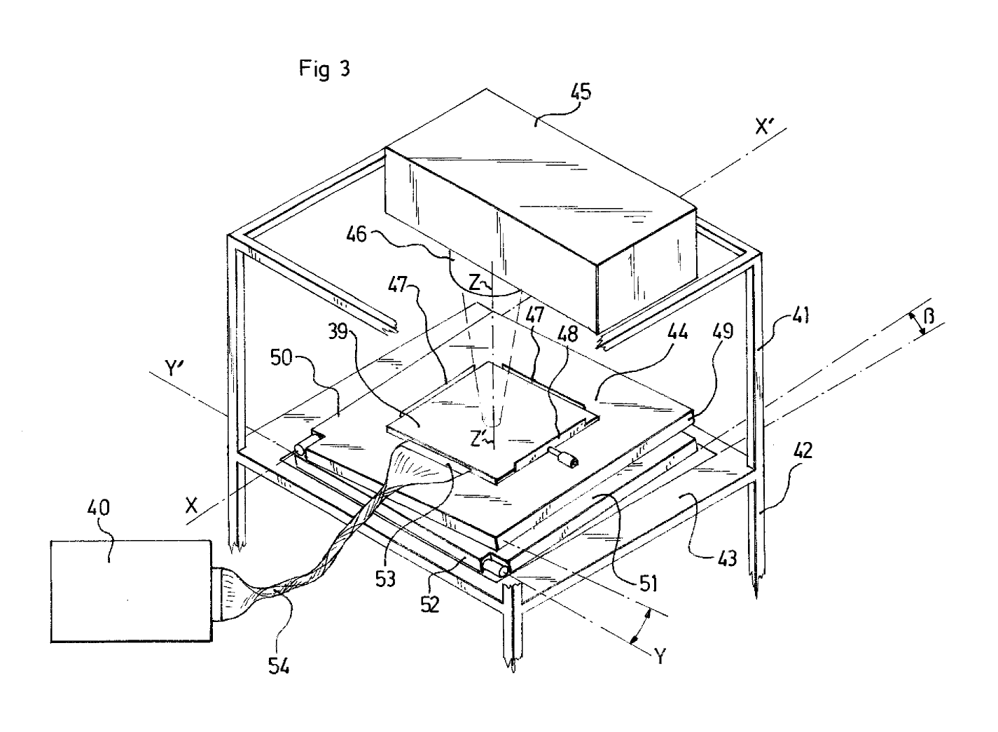

FIG. 3 is a schematic representation of a test machine according to the invention,

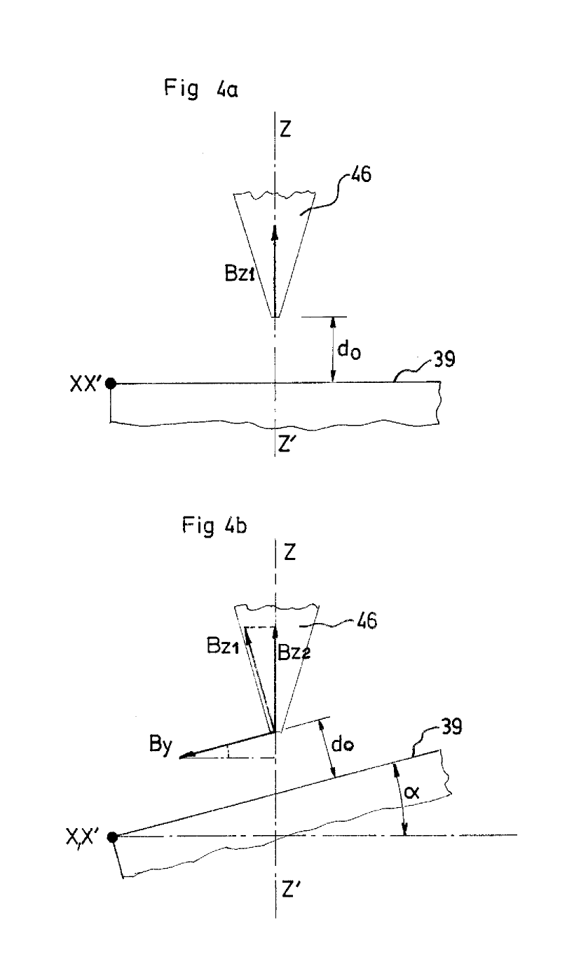

FIGS. 4a and 4b are diagrams respectively illustrating the two positions for measurement of the values Bz1 and Bz2, FIG. 4b illustrating the calculation of a component By of the magnetic field,

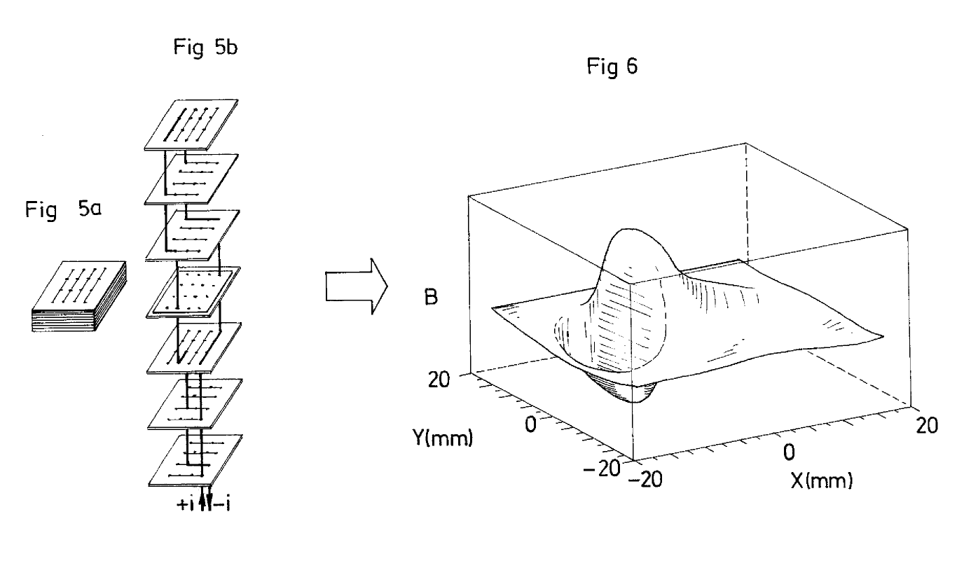

FIG. 5a is a perspective diagram representing an example of an electronic assembly, and FIG. 5b is an exploded perspective diagram representing the electrical circuit of the same electronic assembly,

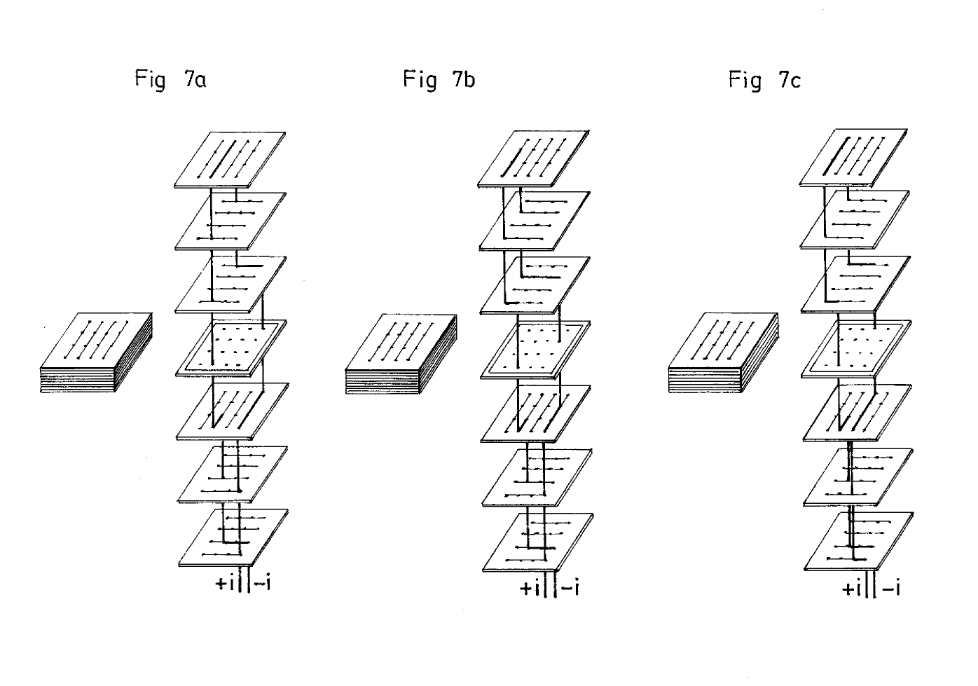

FIG. 6 represents an example of a measured image obtained by a method according to the invention with the electronic assembly of FIGS. 5a and 5b,

FIGS. 7a, 7b, 7c are exploded perspective diagrams representing three examples of fault hypotheses in the electrical circuit of the electronic assembly, and

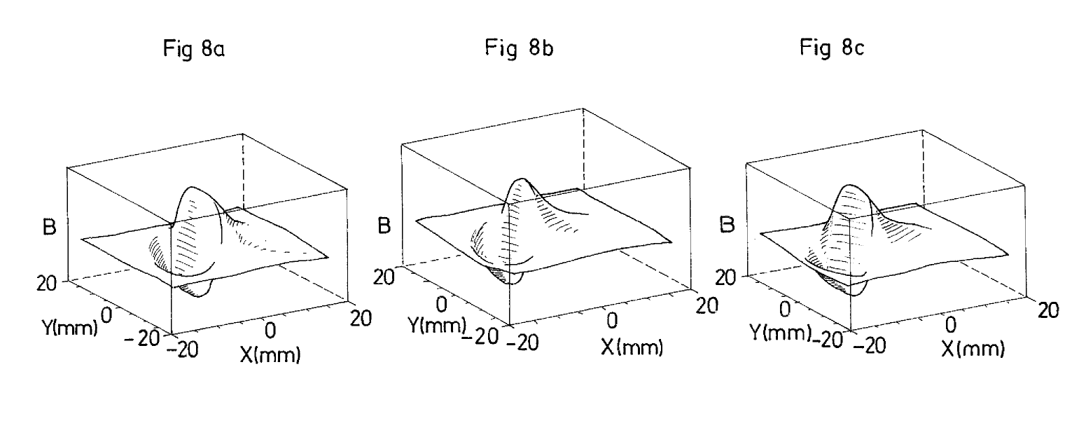

FIGS. 8a, 8b, 8c represent examples of corresponding simulated images.

A test machine according to the invention consists overall of a known machine, for example a magnetic microscope such as that marketed under the reference Magma C30® by the company NEOCERA (Beltsville, Md., USA), this machine being modified as indicated below in order to carry out a method according to the invention. Consequently, only the main characteristics and the specific characteristics of the invention are described below, the other general characteristics of a machine for testing electronic devices being known per se.

A test machine 4 according to the invention comprises a fixed main frame 41 resting on the floor by means of legs 42 and carrying in particular a horizontal worktable 43 on which a reception support 44 is mounted for receiving an electronic device 39 to be tested. The frame 41 also carries an upper console 45 carrying and guiding, at a distance from and above the reception support 44, a monodirectional magnetic-field measurement probe 46, in particular comprising a SQUID sensor, with a vertical axis (orthogonal to the support table 43). The measurement probe 46 is adapted to be able to deliver a signal representative of the value of a component Bz along a predetermined axis ZZ′ which is fixed with respect to said probe 46. The axis ZZ′ is preferably vertical in the embodiment, although there is nothing to prevent the axis of the probe 46 being arranged according to any other orientation, so long as this axis ZZ′ can be secant with the reception support 44, and therefore with an electronic device arranged in this reception support 44.

The test machine 4 according to the invention also comprises a mechanism arranged to be able to place and orientate with respect to one another the probe 46, and more particularly the axis ZZ′, and an electronic device received and fixed in the reception support 44.

This mechanism firstly comprises motorized means which are well known per se (cf. for example the aforementioned Magma C30® machine), making it possible to displace the probe and the reception support 44 with respect to one another in translation along three orthogonal axes, that is to say on the one hand in a horizontal plane (XX′, YY′) parallel to the table 43 and, on the other hand, parallel to the vertical axis ZZ′ of the probe 46. For example, these motorized displacement and positioning means form part of the console 45 carrying the probe 46, this console 45 comprising a gantry-like support having a main horizontal longitudinal bar carried and guided in translation between two horizontal crossbars, the probe 46 itself being guided in translation along the main longitudinal bar, and including a upright for vertical guiding of the magnetic sensor, the various movements being motorized on the basis of a plurality of electric motors associated with encoders for identifying the precise position of the sensor of the probe 46 with respect to the frame 41.

The reception support 44 comprises a bracket 47, 48 for fixing the electronic device, this bracket comprising two fixed bracing elements 47 which are horizontal and mutually orthogonal allowing the electronic device to be immobilized in the horizontal plane with respect to the reception support 44, and on the other hand at least one mobile bracing element 48 mounted so that it can move horizontally with respect to the table 43 in front of one of the fixed bracing elements 47 so as to be able to clamp the electronic device.

This reception support 44 is furthermore carried by a mobile plate 49 of a first table 50 pivoting about a first horizontal axis XX′, itself carried by the mobile plate 51 of a second table 52 pivoting about a second horizontal axis YY′ orthogonal to the first, so that the reception support 44 can be inclined with respect to the horizontal plane of the worktable 43 according to a predetermined angle α about the horizontal axis XX′ and/or according to a predetermined angle β about the horizontal axis YY′.

Each pivoting table 50, 52 makes it possible to keep the angle of inclination α or β of the reception support 44 about the corresponding horizontal axis XX′ or YY′ fixed. Such a pivoting table 50 or 52 may be manually controlled and/or motorized by an electric motor, and is well known per se.

The test machine 4 according to the invention also comprises an automated control unit 40 for on the one hand controlling the various movements of the probe 46 and the reception support 44 in translation and inclination, and on the other hand for driving the overall operation of the machine. This automated control unit 40 is connected on the one hand to the measurement probe 46, and on the other hand to at least one connector 53 which can be connected to an electronic device carried in the reception support 44. This automated control unit 40 comprises a computer device comprising in particular a bulk memory for recording values corresponding to the signals delivered by the probe 46.

The automated control unit 40 is in particular configured to be able to form predetermined test signals which are delivered to the inputs of the electronic device received in the reception support 44. These test signals are formed as a function of each electronic device, in a manner well known per se, for example by using a component tester with the reference D10 marketed by the company CREDENCE SYSTEM CORPORATION (Milpitas, USA), which is part of the automated unit 40. As a variant, instrumentation driver software of the GPIB type (for example the Labview® software marketed by the company National Instruments, France (Le Blanc-Mesnil, France)) may be used, in association with supply circuits, voltmeters, ammeters, for example as marketed by the company Agitent Technologies France (Massy, France).

Furthermore, the test machine 4 according to the invention is configured to be able to perform calculations and digital processing operations, in particular imaging, on the basis of the signals delivered by the monodirectional magnetic probe 46, as indicated below, in order to carry out a test method according to the invention. In order to do this, the automated computer control unit 40 may be programmed for this purpose in any suitable way.

In the first step 10 of a method according to the invention, an electronic device 39 to be tested is put in place and fixed on the reception support 44 of a test machine 4 according to the invention. The electronic device is preferably placed so that it has a large main face oriented upward horizontally. The pivoting tables 50, 52 are placed at angles α and β of zero, the reception support 44 and the electronic device being horizontal.

The measurement probe is then brought to a distance d0 from the electronic device and, for each position of the fixed axis ZZ′ in the horizontal plane, that is to say for each pair of coordinates (x, y) of this ZZ′, a first measurement of the component Bz of the magnetic field emitted by the electronic device is carried out, the latter, connected to the connector 53, being supplied with suitable test signals on its inputs so as to generate currents in its electrical circuits, at least in the parts of this electrical circuit which are intended to be tested. A first value Bz1 (x, y) of the component Bz of the magnetic field is then obtained and recorded.

The probe 46 is then displaced in the horizontal plane, by varying x and y so as to scan the entire circuit, while keeping the same distance d0, and the first value Bz1 (x, y) of the component Bz of the magnetic field is measured and recorded for each position (x, y) (step 11).

The number of measurements carried out in the plane, that is to say the variation increments of the component x (along the axis XX′) and of the coordinate y (along the axis YY′), are selected so as to be able to obtain during step 12, on the basis of the various values Bz1 (x, y), a two-dimensional image in a plane orthogonal to the axis ZZ′ which is representative of the component Bz of the magnetic field emitted by at least one predetermined portion of the circuit. Such an image may be obtained in a manner known per se, for example by means of the software integrated into the aforementioned Magma C30® machine

During the subsequent step 13, the first pivoting table 50 is pivoted and the reception support 44 and the electronic device are therefore inclined by a predetermined angle α with respect to the axis XX′, with a value of more than 10°, preferably between 10° and 30°. A high value of α increases the precision of the result of the calculation, but interferes with bringing the probe 46 to the appropriate distance d0 from the electronic device. On the other hand, β=0 is maintained (no inclination about the axis YY′).

In this position, the measurement of the component Bz of the magnetic field as indicated above is repeated (step 14), while keeping the sensor of the measurement probe 46 at the same distance d0 from the electronic device, and while scanning the same positions (x, y) of the horizontal plane as in step 11. It is to be noted that the height of the measurement probe 46 with respect to the worktable 43 must be modified when the probe 46 is displaced along the axis YY′, in order to keep the probe at the constant distance d0 despite the inclination α.

During step 14, a second value Bz2 (x, y) of the component Bz of the magnetic field is therefore measured and recorded for each position (x, y).

As may be seen in FIG. 4b, by construction:

Bz2=Bz1. cos α−By. sin α

The value of the component By of the magnetic field along the axis YY′ can therefore be deduced therefrom during step 15 for each position (x, y), by the formula:

By=(Bz1. cos α.Bz2)/sin α

This value of the component By of the magnetic field is recorded by the automated unit 40.

Likewise, during the subsequent step 16, the second pivoting table 52 is pivoted and the reception support 44 and the electronic device are therefore inclined by a predetermined angle β with respect to the axis YY′, with a value of more than 10°, preferably between 10° and 30°. A high value of β increases the precision of the result of the calculation, but interferes with bringing the probe 46 to the appropriate distance d0 from the electronic device. On the other hand, α=0 is reset (no inclination about the axis XX′).

In this position, the measurement of the component Bz of the magnetic field as indicated above is repeated (step 17), while keeping the sensor of the measurement probe 46 at the same distance d0 from the electronic device, and while scanning the same positions (x, y) of the horizontal plane as in step 11. The height of the measurement probe 46 with respect to the worktable must also be modified when the probe 46 is displaced along the axis XX′, in order to keep the probe at the constant distance d0 despite the inclination β.

During step 17, a third value Bz3 (x, y) of the component Bz of the magnetic field is therefore measured and recorded for each position (x, y).

As before:

Bz3=Bz1. cos β−Bx. sin β

The value of the component Bx of the magnetic field along the axis XX′ can therefore be deduced therefrom during step 18 for each position (x, y), by the formula:

Bx=(Bz1. cos β−Bz3)/sin β

This value of the component Bx of the magnetic field is recorded by the automated unit 40.

The calculations of the components By and Bx according to the invention assume that the values of the magnetic field emitted by the electronic device are not modified by the inclination α or β. In the embodiment represented and described here, in which the reception support 44 and therefore the electronic device are displaced in order to generate the corresponding inclination, the electronic device is preferably supplied by means of a twisted cable 54 terminating at the connector 53, so that the electric current flowing in this cable 54 does not modify the magnetic field owing to the inclination.

In an alternative embodiment (not shown) it is conversely possible to keep the reception device 44 and the electronic device fixed in a horizontal plane, and to produce the inclinations α and β about the axes XX′ and YY′ by modifying the orientation of the axis of the measurement probe 46 with respect to the frame 41, in which case this measurement probe 46 is mounted with respect to the console 45 by pivot joints so as to be able to be inclined about these axes. In this way, the emitted magnetic field is not modified since the electronic device is not displaced between the various measurement steps.

At the end of the measurement and calculation steps 10 to 18, for each component Bx, By, Bz of the magnetic field emitted by the electronic device, a matrix [Bx (x, y, d0)], [By (x, y, d0)], [Bz (x, y, d0)] is obtained in which the values of said component Bx, By, Bz are recorded for each position (x, y). Each matrix may be visualized in the form of an image, the measured images obtained in this way for these three components being representative of the current circulations in the electronic device, while taking into account the current circulations in all three dimensions, whatever the shapes of the conductive lines.

Such a measured image may subsequently be used in order to detect and localize a fault in the electrical circuit of the electronic device, as described below with reference to FIG. 2.

During the first step 21, a reference electronic device is selected whose electrical circuit 24, which is a reference electrical circuit, is known and fault-free and corresponds to the designed electrical circuit of the electronic device 39 to be tested, in which possible faults are intended to be detected.

During the subsequent step 22, the aforementioned steps 10 to 19 of the test method according to the invention are carried out on the reference electronic device, so as to obtain a matrix and a measured reference image 23 for each component Bx, By, Bz of the magnetic field.

On the basis of the reference electrical circuit 24 which is known and by means of for example of appropriate simulation software, such as the Flux 3D® finite element analysis software marketed by the company CEDRAT Group (Meylan, France) or the circuit element software BIO SAVART® marketed by the company RIPPLON (Burnaby, Canada), during step 25 the various components Bx, By, Bz of the magnetic field as would be emitted by the reference electronic device are calculated, then, for each component Bx, By, Bz, a simulated reference image 26 capable of being obtained in the same way as the measured image is calculated, but on the basis of the components Bx, By, Bz of the magnetic field which have previously been calculated by simulation.

A test 27 is then carried out, by which a check is made that the calibration of the simulation is correct, that is to say that the simulated reference image 26 corresponds to the measured reference image 23. If this is not the case, the simulation step 25 is repeated while correcting the parameters. If the comparison carried out by the test 27 is considered to be correct, the result 28 of this comparison between the two reference images 23 and 26 is recorded.

The user (human operator) then makes a certain number of hypotheses concerning the possible presence of a fault in the electrical circuit of the electronic device 39 to be tested. Each hypothesis is represented by a record 29 of the electrical circuit in a database 30. For each record 29, a simulation step 31 identical to the preceding simulation step 25 is carried out, but with the electrical circuit containing a fault represented by the record 29. At the end of these simulation steps, simulated images are obtained, namely one simulated image 32 for each fault hypothesis, that is to say for each record 29.

Furthermore, during step 33 which may be carried out before, after or during the simulation steps 31, the aforementioned steps 10 to 19 of the test method according to the invention are carried out with the electronic device 39 to be tested so as to obtain the measured image 34 of this electronic device.

During the subsequent step 35, each of the simulated images 32 is compared with the measured image 34 so as to determine the simulated image 32 which has the best correlation with the measured image 34, that is to say a comparison result closest to the result 28 obtained on the basis of the reference electronic device. This comparison 35 may simply be carried out visually by the user (human operator), or entirely automatically by image comparison software, or in semiautomatic combination by a human operator assisted by image comparison software. For example, this image comparison may be carried out with the aid of the image processing software WIT® from the company DALSA Digital Imaging (Burnaby, Canada).

Thus, the use of simulated images obtained by making various hypotheses concerning the possible faults in the circuit makes it possible to detect and localize a fault in an electronic device by virtue of a test method according to the invention, and to do so while obviating any analytical calculation by integration of the components Bx, By, Bz of the magnetic field.

Furthermore, owing to the fact that in the scope of measuring a magnetic field, each contribution of the circuit is added to the others, throughout the method according to the invention it is possible to avoid measurement and/or simulation of the parts of the electronic circuit of the electronic device which do not need to be tested, in particular because these parts are necessarily fault-free.

In order to do so, it is possible in particular to calculate a differential measured image by subtracting the measured reference image 23 from the measured image 34 of the electronic device, and to calculate differential simulated images by subtracting the simulated reference image 26 from each simulated image 32, before carrying out the comparison 35 only on these differential images. It is even possible to produce simulated images only on the parts of the differential measured image which have non-zero values. In this way, the method is greatly simplified and accelerated.

### Example

In the example of FIG. 5a, the electronic device to be tested is an electronic assembly consisting of a stack of seven rectangular boards represented in FIG. 5b. This electronic assembly has a reference electronic circuit represented in FIG. 5b by a circulation of electrical current −i, +i along conduction lines passing through the various boards.

FIG. 6 represents a measured reference image obtained according to the invention with a Magma C30® machine equipped with a SQUID sensor.

FIGS. 7a, 7b, 7c represent three hypotheses of a fault in the electronic circuit, which may be formulated by the operator, each hypothesis being represented by a record 29 of the corresponding electrical circuit in the database 30.

FIGS. 8a, 8b, 8c are the simulated images of the component Bz, corresponding to the three hypotheses above and obtained on the one hand on the basis of the Flux 3D® finite element analysis software making it possible to obtain the various matrices of the different components of the magnetic field, which are represented in the form of images in the same way as the measured image.

As may be seen, the simulated images can subsequently be compared with an image measured according to the invention on a device having a fault, and, on the basis of these simulated images it is possible to find the one which corresponds best to this measured image, and therefore to the fault.

1-16. (canceled)

17. A method for testing an electronic device, in which the magnetic field emitted by at least one circulation of electric current in the electronic device is measured by a monodirectional measurement probe adapted to be able to deliver a signal representative of the value of a component Bz of said magnetic field along a predetermined axis ZZ′ which is fixed with respect to said probe,
wherein:
the probe being brought to a distance d0 in front of one face of the electronic device with the axis ZZ′ secant with the electronic device, and the electronic device being supplied with electrical energy and with predetermined input signals applied to input terminals of the electronic device, for each position (x, y) of the axis ZZ′ with respect to said face, a first value Bz1 of the component of the magnetic field Bz along the axis ZZ′ is measured by the probe and recorded,
then the probe and the electronic device are displaced with respect to one another by relative pivoting about an axis XX′ orthogonal to the axis ZZ′ according to an angular amplitude a of less than 90°, the probe being kept at the same distance d0 in front of the same face of the electronic device, and, the electronic device being supplied with electrical energy and with predetermined input signals, for each position (x, y) of the axis ZZ′ with respect to said face, a second value Bz2 of the component Bz of the magnetic field along the axis ZZ′ is measured by the probe and recorded,
then the value of a component By of the magnetic field along an axis YY′ orthogonal to the axes ZZ′ and XX′ is determined and recorded for each position (x, y) of the axis ZZ′ on the basis of the first value Bz1 and the second value Bz2 which have been obtained.

18. The method as claimed in claim 17, wherein the value of the component By of the magnetic field is calculated according to the formula:
By=(Bz1. cos α−Bz2)/sin α.

19. The method as claimed in claim 17, wherein:
the probe and the electronic device are displaced with respect to one another by relative pivoting about the axis YY′ according to an angular amplitude β of less than 90°, the probe being kept at the same distance d0 in front of the same face of the electronic device, and, the electronic device being supplied with electrical energy and with predetermined input signals, for each position (x, y) of the axis ZZ′ with respect to said face, a third value Bz3 of the component Bz of the magnetic field along the axis ZZ′ is measured by the probe and recorded,
then the value of a component Bx of the magnetic field along an axis XX′ is determined and recorded for each position (x, y) of the axis ZZ′ on the basis of the first value Bz1 and the third value Bz3 which have been obtained.

20. The method as claimed in claim 3, wherein the value of the component Bx of the magnetic field is calculated according to the formula:
Bx=(Bz1. cos β−Bz3)/sin β

21. The method as claimed in claim 17, wherein:
an image, called a measured image, of at least a part of the electronic device is formed on the basis of one of the three components Bx, By, Bz of the magnetic field emitted by this electronic device, as determined on the basis of the measurements provided by said probe for different positions (x, y) of the axis ZZ′ of the probe with respect to said face,
a plurality of simulated images of said part of the electronic device are formed by simulation, each simulated image corresponding to an image capable of being obtained in the same way as the measured image, on the basis of values calculated by simulation, for each position (x, y) of the axis ZZ′ with respect to said face, of the corresponding component Bx, By, Bz of the magnetic field as would be emitted by this electronic device in the presence of at least one fault of the circulation of current in said part of the electronic device,
the simulated images are compared with the measured image.

22. The method as claimed in claim 5, wherein the measured image of said part of the electronic device, which is used for the comparison, corresponds to subtraction of an image obtained on the basis of the corresponding component Bx, By, Bz of the magnetic field emitted by the entirety of a reference electronic device corresponding to the electronic device to be tested but free of faults, this component being measured for each position (x, y) of the axis ZZ′ with respect to said face, and of an image obtained on the basis of the corresponding component Bx, By, Bz of the magnetic field emitted by the entirety of the electronic device to be tested, this component also being measured for each position (x, y) of the axis ZZ′ with respect to said face, and wherein each simulated image is formed by subtraction of an image obtained on the basis of values calculated by simulation, for each position (x, y) of the axis ZZ′ with respect to said face, of the corresponding component Bx, By, Bz of the magnetic field as would be emitted by the entirety of the reference electronic device, and of an image obtained on the basis of values calculated by simulation, for each position (x, y) of the axis ZZ′ with respect to said face, of the corresponding component Bx, By, Bz of the magnetic field as would be emitted by the entirety of the electronic device in the presence of at least one fault.

23. The method as claimed in claim 17, wherein a measurement probe comprising a sensor selected from a SQUID sensor and a magnetoresistive sensor is used.

24. The method as claimed in claim 17, wherein, the electronic device being an electronic assembly in three dimensions, in order to measure said first value Bz1 the probe is oriented with the axis ZZ′ orthogonal to one of the external faces of this electronic assembly.

25. The method as claimed in claim 17, wherein the probe and the electronic device are displaced with respect to one another by relative pivoting according to an angular amplitude of more than 10° and less than 45°—in particular lying between 10 and 30°.

26. A machine for testing an electronic device, comprising:
a monodirectional measurement probe adapted to be able to deliver a signal representative of the value of a component Bz, along a predetermined axis ZZ′ which is fixed with respect to said probe, of the magnetic field emitted in the vicinity of the probe by at least one circulation of electric current in the electronic device,
a support for receiving an electronic device, and means for supplying this electronic device with electrical energy and with predetermined input signals applied to input terminals of the electronic device,
a mechanism suitable for placing the probe and an electronic device received in the reception support with respect to one another, with the axis ZZ′ secant with the reception support,
means for recording values corresponding to the signals delivered by the probe,
wherein:
said mechanism is configured to make it possible to modify, for each position (x, y) of the axis ZZ′ with respect to the electronic device, the orientation of the probe and the electronic device with respect to one another, by relative pivoting about an axis XX′ orthogonal to the axis ZZ′ according to an angular amplitude of less than 90°, the probe being kept at a distance d0 in front of the same face of the electronic device,
said test machine comprises calculation means configured to determine and record, for each position (x, y) of the axis ZZ′, the value of a component By of the magnetic field along an axis YY′ orthogonal to the axes ZZ′ and XX′, on the basis of a first value Bz1 of the component Bz of the magnetic field along the axis ZZ′ as measured by the probe in a first relative angular position of the probe and of the electronic device with respect to the axis XX′, and of a second value Bz2 of the component Bz of the magnetic field along the axis ZZ′ as measured by the probe in a second relative angular position of the probe and of the electronic device with respect to the axis XX′, and at the same distance d0, said first and second angular positions with respect to the axis XX′ being separated from one another by an angle of less than 90°.

27. The machine as claimed in claim 26, wherein said mechanism is configured to make it possible to modify the orientation of the probe and the electronic device with respect to one another, by relative pivoting about the axis YY′ according to an angular amplitude of less than 90°, the probe being kept at the same distance d0 in front of the same face of the electronic device, and wherein said calculation means are configured to determine and record, for each position (x, y) of the axis ZZ′, the value of a component Bx of the magnetic field along the axis XX′, on the basis of a first value Bz1 of the component Bz of the magnetic field along the axis ZZ′ as measured by the probe in a first relative angular position of the probe and of the electronic device with respect to the axis YY′, and of a third value Bz3 of the component Bz of the magnetic field along the axis ZZ′ as measured by the probe in a second relative angular position of the probe and of the electronic device with respect to the axis YY′, and at the same distance d0, said first and second angular positions with respect to the axis YY′ being separated from one another by an angle of less than 90°.

28. The machine as claimed in claim 26, which furthermore comprises:
means for generating an image, called a measured image on the basis of one of the three components Bx, By, Bz of the magnetic field emitted by this electronic device, as determined on the basis of the measurements provided by said probe for different positions (x, y) of the axis ZZ′ of the probe with respect to said face,
means for calculating calculated values by simulation, for each position (x, y) of the axis ZZ′ with respect to said face, of the three components Bx, By, Bz of the magnetic field as would be emitted by said part of the electronic device in the presence of at least one fault of the circulation of current in said part of the electronic device,
means for generating a plurality of simulated images of said part of the electronic device by simulation, each simulated image corresponding to an image capable of being obtained in the same way as the measured image, on the basis of a set of said values calculated by simulation, for each position (x, y) of the axis ZZ′ with respect to said face, of the corresponding component Bx, By, Bz of the magnetic field.

29. The machine as claimed in claim 26, wherein said probe comprises a sensor selected from a SQUID sensor and a magnetoresistive sensor.

30. The machine as claimed in claim 26, wherein:
the reception support is arranged to be able to receive an electronic device formed by an electronic assembly in three dimensions,
the mechanism is configured to make it possible to orientate the probe with the axis ZZ′ orthogonal to one of the external faces of an electronic assembly received in said support.

31. The machine as claimed in claim 26, wherein the support for receiving the electronic device is fixed with respect to a frame, and wherein said mechanism is configured to make it possible to pivot the probe with respect to this frame.

32. The machine as claimed in claim 26, wherein the probe is mounted with respect to a frame so as to have a fixed orientation of the axis ZZ′ with respect to the frame, wherein the mechanism is configured to make it possible to pivot the support for receiving the electronic device with respect to the frame and wherein the electronic device received in the support is supplied by means of a twisted cable.

33. The method as claimed in claim 18, wherein:
the probe and the electronic device are displaced with respect to one another by relative pivoting about the axis YY′ according to an angular amplitude β of less than 90°, the probe being kept at the same distance d0 in front of the same face of the electronic device, and, the electronic device being supplied with electrical energy and with predetermined input signals, for each position (x, y) of the axis ZZ′ with respect to said face, a third value Bz3 of the component Bz of the magnetic field along the axis ZZ′ is measured by the probe and recorded,
then the value of a component Bx of the magnetic field along an axis XX′ is determined and recorded for each position (x, y) of the axis ZZ′ on the basis of the first value Bz1 and the third value Bz3 which have been obtained.

34. The method as claimed in claim 18, wherein:
an image, called a measured image, of at least a part of the electronic device is formed on the basis of one of the three components Bx, By, Bz of the magnetic field emitted by this electronic device, as determined on the basis of the measurements provided by said probe for different positions (x, y) of the axis ZZ′ of the probe with respect to said face,
a plurality of simulated images of said part of the electronic device are formed by simulation, each simulated image corresponding to an image capable of being obtained in the same way as the measured image, on the basis of values calculated by simulation, for each position (x, y) of the axis ZZ′ with respect to said face, of the corresponding component Bx, By, Bz of the magnetic field as would be emitted by this electronic device in the presence of at least one fault of the circulation of current in said part of the electronic device,
the simulated images are compared with the measured image.

35. The method as claimed in claim 19, wherein:
an image, called a measured image, of at least a part of the electronic device is formed on the basis of one of the three components Bx, By, Bz of the magnetic field emitted by this electronic device, as determined on the basis of the measurements provided by said probe for different positions (x, y) of the axis ZZ′ of the probe with respect to said face,
a plurality of simulated images of said part of the electronic device are formed by simulation, each simulated image corresponding to an image capable of being obtained in the same way as the measured image, on the basis of values calculated by simulation, for each position (x, y) of the axis ZZ′ with respect to said face, of the corresponding component Bx, By, Bz of the magnetic field as would be emitted by this electronic device in the presence of at least one fault of the circulation of current in said part of the electronic device,
the simulated images are compared with the measured image.

36. The method as claimed in claim 20, wherein:
an image, called a measured image, of at least a part of the electronic device is formed on the basis of one of the three components Bx, By, Bz of the magnetic field emitted by this electronic device, as determined on the basis of the measurements provided by said probe for different positions (x, y) of the axis ZZ′ of the probe with respect to said face,
a plurality of simulated images of said part of the electronic device are formed by simulation, each simulated image corresponding to an image capable of being obtained in the same way as the measured image, on the basis of values calculated by simulation, for each position (x, y) of the axis ZZ′ with respect to said face, of the corresponding component Bx, By, Bz of the magnetic field as would be emitted by this electronic device in the presence of at least one fault of the circulation of current in said part of the electronic device,
the simulated images are compared with the measured image.
